(19) United States
(12) Patent Application Publication
(10) Pub. No.: US 2012/0060218 A1
(43) Pub. Date: Mar. 8, 2012

(54) SYSTEM AND METHOD FOR BLOCKING SIP-BASED ABNORMAL TRAFFIC

(76) Inventors: JEONG-WOOK KIM, Seoul (KR); Hwan-Kuk Kim, Seoul (KR); Kyoung-Hee Ko, Incheon (KR); Chang-Yong Lee, Seoul (KR); Hyun-Cheol Jeong, Seoul (KR)

(21) Appl. No.: 12/943,388

(22) Filed: Nov. 10, 2010

(30) Foreign Application Priority Data
Sep. 2, 2010 (KR) 10-2010-0085782

(51) Int. Cl. G06F 11/00

(52) U.S. Cl. 726/23

(57) ABSTRACT

Provided is a system for blocking session initiation protocol (SIP)-based abnormal traffic. The system includes: a policy database (DB) in which allowed traffic is stored according to transmission priority; an abnormal traffic response module which receives traffic from a first network and transmits only portions of the received traffic, which match the allowed traffic stored in the policy DB, to a second network in order of transmission priority; and an abnormal traffic detection module which analyzes the traffic received from the first network and provides an activation signal to the abnormal traffic response module when detecting that the received traffic is abnormal traffic, wherein the abnormal traffic response module transmits the portions of the received traffic, which match the allowed traffic stored in the policy DB, to the second network such that the sum of the portions transmitted to the second network does not exceed a maximum allowed traffic limit.

### RELATED APPLICATION

This application claims priority from Korean Patent Application No. 10-2010-0085782 filed on Sep. 2, 2010 in the Korean Intellectual Property Office, the disclosure of which is incorporated herein by reference in its entirety.

### BACKGROUND OF THE INVENTION

1. Field of the Invention

The present invention relates to a system and method for blocking session initiation protocol (SIP)-based abnormal traffic.

2. Description of the Related Art

Session initiation protocol (SIP) is an application-level protocol that is used for creating, modifying, and terminating multimedia sessions. Examples of services based on the SIP include voice over Internet protocol (VoIP), instant messaging, and video conferencing services. These SIP-based services are becoming more closely related to the lives of people today.

However, as the SIP-based services become more common, various malicious attacks using the SIP-based services are increasing day by day. Major examples of such malicious attacks include denial-of-service (DoS) attacks and spam over Internet telephony (SPIT) attacks using SIP request and response messages. Also, toll fraud attacks and call hijacking attacks occur frequently.

Therefore, for smooth service provision, there is a need for a technology that can selectively provide normal SIP traffic while blocking abnormal traffic generated for the purpose of malicious attacks.

### SUMMARY OF THE INVENTION

Aspects of the present invention provide a system for blocking session initiation protocol (SIP)-based abnormal traffic, which selectively provides normal SIP traffic while blocking abnormal traffic generated for the purpose of malicious attacks.

Aspects of the present invention also provide a method of blocking SIP-based abnormal traffic, in which normal SIP traffic is selectively provided, while abnormal traffic generated for the purpose of malicious attacks is blocked.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a system for blocking SIP-based abnormal traffic. The system includes: a policy database (DB) in which allowed traffic is stored according to transmission priority; an abnormal traffic response module which receives traffic from a first network and transmits only portions of the received traffic, which match the allowed traffic stored in the policy DB, to a second network in order of transmission priority; and an abnormal traffic detection module which analyzes the traffic received from the first network and provides an activation signal to the abnormal traffic response module when detecting that the received traffic is abnormal traffic, wherein the abnormal traffic response module transmits the portions of the received traffic, which match the allowed traffic stored in the policy DB, to the second network such that the sum of the portions transmitted to the second network does not exceed a maximum allowed traffic limit.

According to another aspect of the present invention, there is provided a method of blocking SIP-based abnormal traffic. The method includes: receiving traffic from a first network; detecting whether the received traffic is abnormal traffic; and, when the received traffic is the abnormal traffic, transmitting only allowed portions of the received traffic to a second network in order of transmission priority such that the sum of the allowed portions transmitted to the second network does not exceed a maximum allowed traffic limit.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram of a system for blocking session initiation protocol (SIP)-based abnormal traffic according to an exemplary embodiment of the present invention;

FIG. 2 is a diagram illustrating an activation signal transmitted from an abnormal traffic detection module to an abnormal traffic response module;

FIG. 3 is a diagram illustrating allowed portions of input traffic which are transmitted in order of transmission priority; and

FIG. 4 is a block diagram of a system for blocking SIP-based abnormal traffic according to another exemplary embodiment of the present invention.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. In the drawings, sizes and relative sizes of elements may be exaggerated for clarity.

Like reference numerals refer to like elements throughout the specification. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “made of,” when used in this specification, specify the presence of stated components, steps, operations, and/or elements, but do not preclude the presence or addition of one or more other components, steps, operations, elements, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

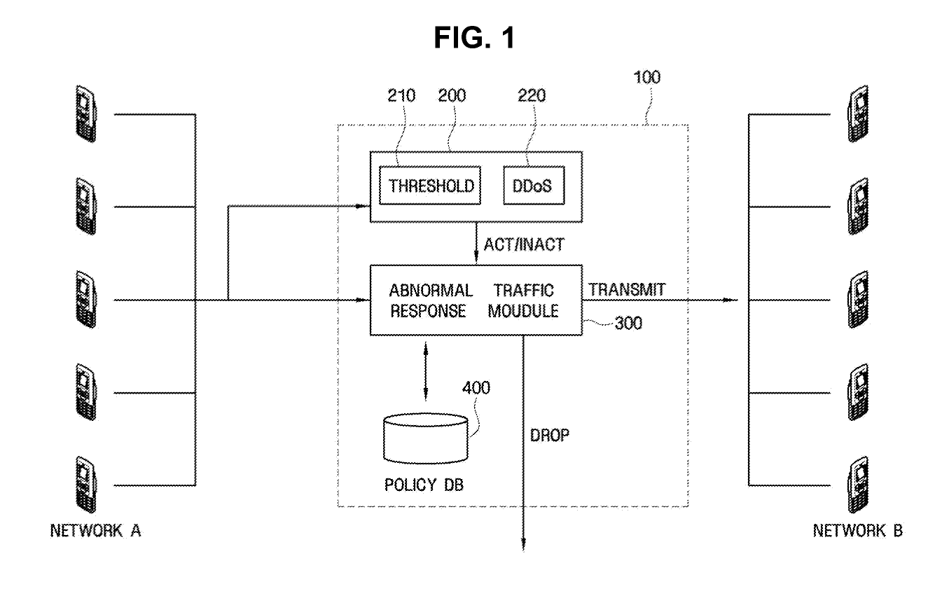

Hereinafter, a system for blocking session initiation protocol (SIP)-based abnormal traffic according to an exemplary embodiment of the present invention will be described with reference to FIGS. 1 through 3.

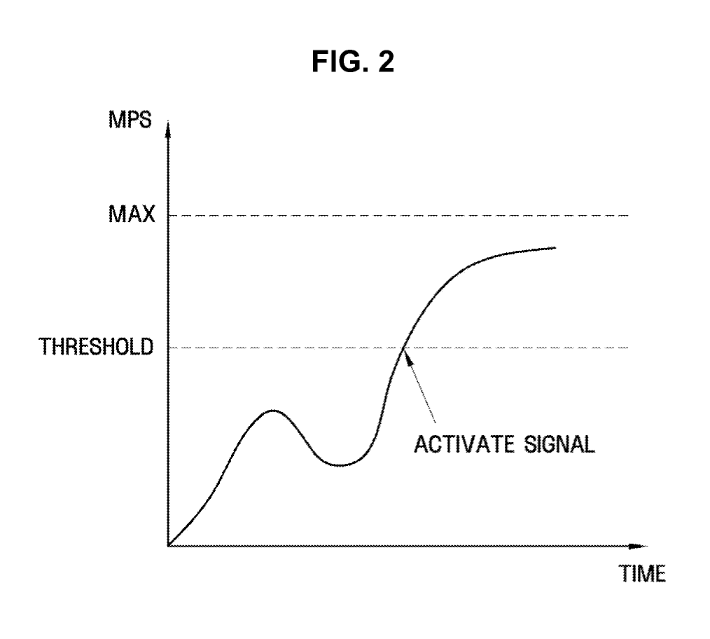

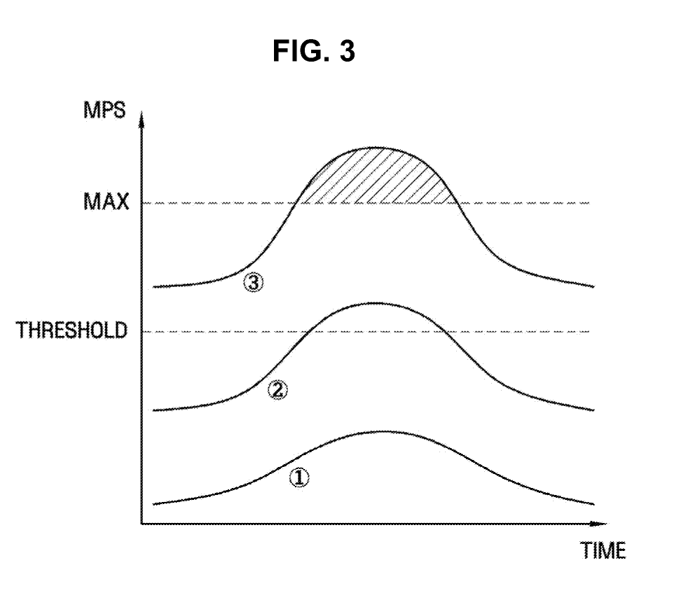

FIG. 1 is a block diagram of a system 100 for blocking SIP-based abnormal traffic according to an exemplary embodiment of the present invention. FIG. 2 is a diagram illustrating an activation signal transmitted from an abnormal traffic detection module 200 to an abnormal traffic response module 300. FIG. 3 is a diagram illustrating allowed portions of input traffic which are transmitted in order of transmission priority.

Referring to FIG. 1, the system 100 for blocking SIP-based abnormal traffic according to the current exemplary embodiment may include the abnormal traffic detection module 200, the abnormal traffic response module 300, and a policy database (DB) 400.

The abnormal traffic detection module 200 may analyze traffic received from a first network NETWORK A and provide an activation signal ACT to the abnormal traffic response module 300 when detecting that the received traffic is abnormal traffic and provide a deactivation signal INACT to the abnormal traffic response module 300 when detecting that the received traffic is normal traffic. The abnormal traffic response module 300 is enabled by the activation signal ACT transmitted from the abnormal traffic detection module 200. When receiving the deactivation signal INACT from the abnormal traffic detection module 200, the abnormal traffic response module 300 provides the traffic received from the first network NETWORK A to a second network NETWORK B without processing the traffic.

The first network NETWORK A may be an SIP-based network that provides voice over Internet protocol (VoIP) services, instant messaging services, video conferencing services, and the like. The second network NETWORK B may also be an SIP-based network.

The abnormal traffic detection module 200 may include a threshold-based determination module 210 and a distributed denial-of-service (DDoS) attack determination module 220 to determine whether input traffic is normal or abnormal.

The threshold-based determination module 210 may transmit the activation signal ACT to the abnormal traffic response module 300 when the sum of traffic received from the first network NETWORK A exceeds a threshold.

More specifically, referring to FIG. 2, when the sum of SIP request message traffic and SIP response message traffic input per second (i.e., the sum of messages per second (MPS)) among traffic input from the first network NETWORK A exceeds a threshold THRESHOLD, the threshold-based determination module 210 may provide the activation signal ACT to the abnormal traffic response module 300. That is, in FIG. 2, the ‘ACTIVATE SIGNAL’ is not generated when the sum of the SIP request message traffic and the SIP response message traffic input per second among the input traffic does not exceed the threshold THRESHOLD and is generated when the sum of the SIP request message traffic and the SIP response message traffic input per second among the input traffic exceeds the threshold THRESHOLD.

As for the threshold THRESHOLD, an administrator may calculate a threshold value in view of network traffic conditions and then input the calculated threshold value to the threshold-based determination module 210. Alternatively, the threshold-based determination module 210 may calculate a threshold value in real time according to input traffic and based on traffic information stored in the policy DB 400.

The DDoS attack determination module 220 may provide the activation signal ACT to the abnormal traffic response module 300 when detecting that input traffic is DDoS attack traffic.

Specifically, the DDoS attack determination module 220 may analyze, for example, the SIP traffic volume, method rate, and uniform resource identifier (URI) rate of input traffic and provide the activation signal ACT to the abnormal traffic response module 300 when determining that the input traffic includes malicious DDoS attack traffic.

Referring back to FIG. 1, the policy DB 400 may be a DB in which allowed traffic is stored according to transmission priority. Specifically, information about SIP message traffic for which a session has already been established may be stored in the policy DB 400 as first-priority allowed traffic, information about session establishment request traffic transmitted from a terminal (e.g., a telephone), which is currently not having an established session but has a history of establishing a session, may be stored as second-priority allowed traffic, and information about traffic permitted by an administrator may be stored as third-priority allowed traffic.

The abnormal traffic response module 300 may receive traffic from the first network NETWORK A and transmit only portions of the received traffic, which match the allowed traffic stored in the policy DB 400, to the second network NETWORK B in order of transmission priority. Here, the abnormal traffic response module 300 may transmit the above portions of the received traffic to the second network NETWORK B such that the sum of the portions transmitted to the second network NETWORK B does not exceed a maximum allowed traffic limit. This will be described in more detail with reference to FIG. 3.

The abnormal traffic response module 300 enabled by the activation signal ACT analyzes traffic received from the first network NETWORK A and transmits portions of the received traffic, which match traffic stored in the policy DB 400 as the first-through third-priority allowed traffic, to the second network NETWORK B. On the other hand, the abnormal traffic response module 300 drops, that is, blocks the transmission of portions of the received traffic, which do not match the allowed traffic stored in the policy DB 400, to the second network NETWORK B because these portions are highly likely to be malicious attack traffic.

Here, when the sum of the portions of the received traffic, which match the traffic stored in the policy DB 400 as the first-through third-priority allowed traffic, does not exceed a maximum allowed traffic limit MAX, all of the portions are transmitted to the second network NETWORK B. However, when the sum of the portions of the received traffic, which match the traffic stored in the policy DB 400 as the first-through third-priority traffic, exceeds the maximum allowed traffic limit MAX, the portions are blocked from being transmitted to the second network NETWORK B in order of lowest to highest priority.

For example, referring to FIG. 3, the sum of first-priority allowed traffic \textcircled{1} and second-priority allowed traffic \textcircled{2} does not exceed the maximum allowed traffic limit MAX. Therefore, portions of input traffic, which match the first-priority allowed traffic \textcircled{1} and the second-priority allowed traffic \textcircled{2}, can all be transmitted to the second network NETWORK B. However, part (shown as a hatched region) of a portion of the input traffic, which matches third-priority allowed traffic \textcircled{3}, may be blocked from being transmitted to the second network NETWORK B. In other words, when the sum of allowed portions of input traffic exceeds the maximum allowed traffic limit MAX, for example, SIP message traffic for which a session has already been established and session establishment request traffic transmitted from a terminal (e.g., a telephone) which has a history of establishing a session can all be transmitted to the second network NETWORK B. However, part of traffic permitted by an administrator may be blocked from being transmitted to the second network NETWORK B.

The above-described priority order of the allowed traffic stored in the policy DB 400 is only an example, and the present invention is not limited to this example. That is, the priority order and content of the allowed traffic can be changed as desired at any time.

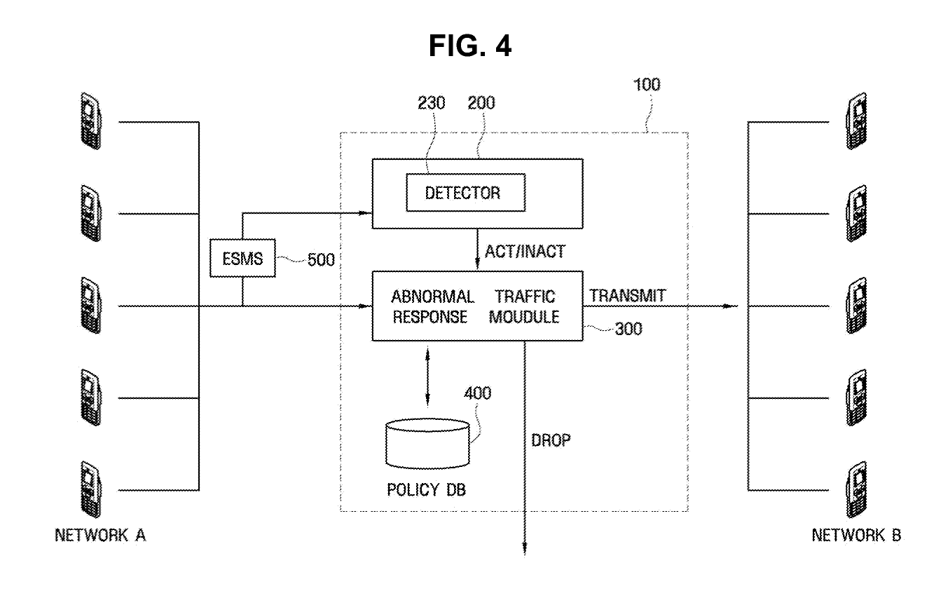

Hereinafter, a system for blocking SIP-based abnormal traffic according to another exemplary embodiment of the present invention will be described with reference to FIG. 4.

FIG. 4 is a block diagram of a system 100 for blocking SIP-based abnormal traffic according to another exemplary embodiment of the present invention. A description of features identical to the above-described features of the system 100 according to the previous exemplary embodiment will be omitted. That is, the following description will focus on differences from the previous exemplary embodiment. Like reference numerals in the drawings denote like elements.

Referring to FIG. 4, an abnormal traffic detection module 200 of the system 100 for blocking SIP-based abnormal traffic according to the current exemplary embodiment may include an external signal detection module 230. When receiving from an external security system 500 a signal indicating that input traffic is abnormal traffic, the external signal detection module 230 may provide an activation signal ACT to an abnormal traffic response module 300. Here, the external security system 500 may be an enterprise security management system (ESMS), and the ESMS may be a system installed in an intra-organizational network to perform enterprise-wide security management. Since other features of the system 100 have been described above, a redundant description thereof is omitted.

Hereinafter, a method of blocking SIP-based abnormal traffic according to an exemplary embodiment of the present invention will be described with reference to FIGS. 1 through 4.

First, traffic is input from the first network NETWORK A. Then, it is detected whether the input traffic is abnormal traffic.

Specifically, referring to FIG. 1, the abnormal traffic detection module 200 may receive traffic from the first network NETWORK A and detect whether the input traffic is abnormal traffic. Here, the abnormal traffic detection module 200 may detect the input traffic as abnormal traffic, for example, when the sum of SIP request message traffic and SIP response message traffic input per second among the input traffic exceeds a threshold value (see FIG. 2), when the input traffic is detected as DDoS attack traffic, or when receiving from an external security system a signal indicating that the input traffic is abnormal traffic (see FIG. 4).

When detecting that the input traffic is abnormal traffic, the abnormal traffic detection module 200 transmits the activation signal ACT to the abnormal traffic response module 300. The abnormal traffic response module 300 is enabled by the activation signal ACT. Then, the enabled abnormal traffic response module 300 transmits only allowed portions of the input traffic to the second network NETWORK B as illustrated in FIG. 3 and drops unallowed portions of the input traffic. When the sum of the allowed portions of the input traffic exceeds a maximum allowed traffic limit, allowed portions having a low priority are dropped, whereas allowed portions having a high priority are transmitted to the second network NETWORK B.

On the contrary, when detecting that the input traffic is normal traffic, the abnormal traffic detection module 200 transmits the deactivation signal INACT to the abnormal traffic response module 300. The abnormal traffic response module 300 is disabled by the deactivation signal INACT. Then, the disabled abnormal traffic response module 300 transmits the traffic received from the first network NETWORK A to the second network NETWORK B without processing the input traffic.

A system for blocking SIP-based abnormal traffic according to an exemplary embodiment of the present invention, which operates as described above, can provide SIP-based services despite an explosive increase in the amount of input traffic due to abnormal traffic by selectively transmitting normal SIP traffic in order of priority. In addition, the system can efficiently utilize the entire network resources by blocking the abnormal traffic generated for the purpose of malicious attacks. Furthermore, the system can prevent network overload resulting from malicious attacks by using a maximum allowed traffic limit.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A system for blocking session initiation protocol (SIP)-based abnormal traffic, the system comprising:
a policy database (DB) in which allowed traffic is stored according to transmission priority;
an abnormal traffic response module which receives traffic from a first network and transmits only portions of the received traffic, which match the allowed traffic stored in the policy DB, to a second network in order of transmission priority; and
an abnormal traffic detection module which analyzes the traffic received from the first network and provides an activation signal to the abnormal traffic response module when detecting that the received traffic is abnormal traffic,
wherein the abnormal traffic response module transmits the portions of the received traffic, which match the allowed traffic stored in the policy DB, to the second network such that the sum of the portions transmitted to the second network does not exceed a maximum allowed traffic limit.

2. The system of claim 1, wherein the abnormal traffic detection module comprises a threshold-based determination module which provides the activation signal to the abnormal traffic response module when the sum of SIP request message traffic and SIP response message traffic input per second among the received traffic exceeds a threshold.

3. The system of claim 2, wherein the threshold is a value input by an administrator to the threshold-based determination module.

4. The system of claim 2, wherein the threshold is a value calculated in real time according to the received traffic.

5. The system of claim 1, wherein the abnormal traffic detection module comprises a distributed denial-of-service (DDoS) attack determination module which provides the activation signal to the abnormal traffic response module when detecting that the received traffic is DDoS attack traffic.

6. The system of claim 1, wherein the abnormal traffic detection module comprises an external signal detection module which provides the activation signal to the abnormal traffic response module when receiving from an external security system a signal indicating that the received traffic is the abnormal traffic.

7. The system of claim 1, wherein SIP message traffic for which a session has been established is stored in the policy DB as first-priority allowed traffic, session establishment request traffic received from a terminal registered with the policy DB is stored in the policy DB as second-priority allowed traffic, and traffic permitted by the administrator is stored in the policy DB as third-priority allowed traffic.

8. A method of blocking SIP-based abnormal traffic, the method comprising:
receiving traffic from a first network;
detecting whether the received traffic is abnormal traffic; and
when the received traffic is the abnormal traffic, transmitting only allowed portions of the received traffic to a second network in order of transmission priority such that the sum of the allowed portions transmitted to the second network does not exceed a maximum allowed traffic limit.

9. The method of claim 8, wherein the detecting of whether the received traffic is the abnormal traffic comprises detecting the received traffic as the abnormal traffic when the sum of SIP request message traffic and SIP response message traffic input per second among the received traffic exceeds a threshold.

10. The method of claim 8, wherein the detecting of whether the received traffic is the abnormal traffic comprises detecting the received traffic as the abnormal traffic when detecting that the received traffic is DDoS attack traffic.

11. The method of claim 8, wherein the detecting of whether the received traffic is the abnormal traffic comprises detecting the received traffic as the abnormal traffic when receiving from an external security system a signal indicating that the received traffic is the abnormal traffic.

12. The method of claim 8, wherein the transmitting of only the allowed portions of the received traffic to the second network in order of transmission priority comprises transmitting, among the received traffic, SIP message traffic for which a session has been established to the second network as first-priority allowed traffic, transmitting session establishment request traffic received from a registered terminal to the second network as second-priority allowed traffic, and transmitting traffic permitted by an administrator to the second network as third-priority allowed traffic.
